(19) United States
(12) Patent Application Publication
(10) Pub. No.: US 2026/0137038 A1
(43) Pub. Date: May 21, 2026

(54) METHOD FOR PLANTING NITRARIA TANGUTORUM IN SUMMER

(71) Applicant: Xinjiang Institute of Ecology and Geography, Chinese Academy of Sciences, Urumqi (CN)

(72) Inventors: Guojun Liu, Urumqi (CN); Jinglong Fan, Urumqi (CN); Shengyu Li, Urumqi (CN); Congjuan Li, Urumqi (CN); Ran Liu, Urumqi (CN); Jiangping Gong, Urumqi (CN); Tian Guang Ma, Urumqi (CN)

(21) Appl. No.: 19/356,248

(22) Filed: Oct. 13, 2025

(30) Foreign Application Priority Data
Nov. 21, 2024 (CN) 2024116751837

(51) Int. Cl. A01G 22/05; A01C 21/00; A01G 9/029; A01G 13/21; A01G 25/00

(52) U.S. Cl. CPC A01G 22/05; A01C 21/005; A01G 9/0291; A01G 9/0299; A01G 13/21; A01G 25/00

(57) ABSTRACT

A method for planting N. tangutorum in summer, includes: seedling cultivation: customizing a square seedling plot on a flat surface, mixing sandy soil, loam, and farmyard manure in a ratio of 3:6:1, sowing N. tangutorum seeds in non-woven bags at a depth of 2 centimeters, and maintaining a humidity; seedling lifting: gently removing, when seedlings grow to a height of 10-20 centimeters, the seedlings along with the non-woven bags to ensure the integrity; transportation: placing the seedlings into plastic transport boxes and trimming stems to ensure tight arrangement; transplanting: digging planting holes, placing nutrient bowl seedlings into the planting holes respectively, and back filling and firming down soil; planting: planting with a row spacing of 3 meters and a plant spacing of 1 meter, and then watering thoroughly for settling-in root; shade net installation: installing a shade net on each N. tangutorum seedling; and irrigation: performing watering every three days.

### TECHNICAL FIELD

The disclosure relates to the technical field of plant planting, and more particularly to a method for planting Nitraria tangutorum (i.e., N. tangutorum, N. tangutorum Bobrov) in summer.

### BACKGROUND

N. tangutorum Bobrov is an important plant belonging to the family Nitrariaceae and the genus Nitraria. The N. tangutorum is widely distributed in arid and semi-arid regions, especially in deserts and saline-alkali lands. Due to its tenacious growth characteristics, the N. tangutorum not only plays a significant role in natural ecosystems but is also extensively utilized by humans. The extensive root system of the N. tangutorum can penetrate deep into the soil, enhancing soil structure and reducing water evaporation, thereby effectively preventing land desertification and serving as a sand-fixing and sand-blocking agent.

The fruit of N. tangutorum is rich in nutrients, including vitamins, amino acids, and polysaccharides, etc., and have significant economic and medicinal value. These fruits are not only edible but are also used to make beverages, wine, and vinegar, thus occupying an important position in the local economy. Additionally, the medicinal value of the N. tangutorum has attracted considerable attention. The N. tangutorum has a sweet taste and sour flavor, and is known for its functions of strengthening the spleen and promoting digestion, lactation, and sedation. The N. tangutorum is commonly used to treat symptoms such as spleen and stomach weakness and indigestion. Moreover, the N. tangutorum is also regarded as an excellent feed source. Livestock such as pigs can grow effectively after consuming the N. tangutorum.

Despite the significant ecological and economic benefits of planting the N. tangutorum, traditional planting methods mainly focus on winter or autumn and face many challenges. In arid regions such as Xinjiang, China, the winter planting period is short, and the preservation and transportation of seedlings are difficult, resulting in survival rates that are usually below the ideal level. Especially in spring and winter, due to factors such as temperature fluctuations and insufficient precipitation, the seedlings are prone to damage, which affects their survival rate. Furthermore, when planting bare-root seedlings in summer, the high temperature and dry environmental conditions make it difficult for the root system to adapt, leading to an even lower survival rate. This seriously restricts the promotion and application of the N. tangutorum.

Therefore, the disclosure proposes a method for planting the N. tangutorum in summer to address the shortcomings in the related art.

### SUMMARY

The disclosure aims to provide a method for planting N. tangutorum in summer, so as to overcome the problem of low survival rate when planting N. tangutorum in high-temperature and arid environments in the related art. Through a series of optimized measures for seedling cultivation, transplantation, irrigation, and shading, the growth and survival rate of N. tangutorum in summer are significantly improved, particularly giving the N. tangutorum a competitive advantage in harsh environments such as arid and saline-alkali lands.

In order to achieve the above purpose, the disclosure is achieved through the following technical solutions. The method for planting N. tangutorum in summer includes the following steps:
(1), seedling cultivation, including: customizing a square seedling plot on a flat surface, mixing sandy soil, loam, and farmyard manure to obtain a mixture, filling the mixture into non-woven bags, sowing N. tangutorum seeds at a depth of 2 centimeters, and maintaining an appropriate humidity before seedling emergence;
(2), seedling lifting, including: gently removing, when seedlings grow to a height of 10-20 centimeters, the seedlings along with the non-woven bags to ensure integrity of the seedlings to obtain removed seedlings;
(3), seedling transportation, including: placing the removed seedlings into plastic transport boxes and trimming stems to ensure that the seedlings are arranged tightly in the plastic transport boxes to obtain prepared nutrient bowl seedlings;
(4), transplanting, including: digging planting holes in a N. tangutorum planting area, placing the prepared nutrient bowl seedlings (also referred to as container-grown seedlings or non-woven bag-grown seedlings) into the planting holes respectively, and back filling and gently firming down soil with feet;
(5), planting, including: planting according to specifications of a row spacing of 3 meters and a plant spacing of 1 meter, and then immediately watering thoroughly for settling-in root to keep the soil moist;
(6), shade net installation, including: installing a shade net on each N. tangutorum seedling after the planting for seedling protection; and
(7), irrigation, including: performing watering every three days to ensure adequate soil moisture.

In an embodiment, before the sowing N. tangutorum seeds at a depth of 2 centimeters, step (1) further includes: soaking the N. tangutorum seeds in warm water or boiled water for a period of 15-30 minutes, and performing a mechanical seed coat removing method or a chemical soaking method.

In an embodiment, in step (1), a mixed ratio of the sandy soil to the loam to the farmyard manure is 3:6:1.

In an embodiment, in step (3), a height of each of the plastic transport boxes is 30 centimeters, and step (3) further includes: laying, when loading the removed seedlings, a layer of soft material including straw, sponge, or a foam pad at a bottom of each of the plastic transport boxes to reduce vibration and damage to root systems of the removed seedlings during transportation.

In an embodiment, in step (4), a dimension of each of the planting holes is 30 centimeters×30 centimeters×30 centimeters.

In an embodiment, step (5) further includes: watering every three days within 1 to 2 weeks after the planting.

In an embodiment, step (6) further includes: removing the shade net after each N. tangutorum seedling has grown for 5 days.

In an embodiment, step (7) further includes: after each N. tangutorum seedling has survived for 10 days, adjusting, based on a seedling growth condition and an environmental humidity, an irrigation frequency to watering every 10 days, where an amount of water each time is 30%-50% of a soil volume of the planting holes to maintain moisture required for normal growth.

In an embodiment, step (2) further includes: watering thoroughly one day before the seedling lifting, to increase soil moisture, ensure integrity of root systems of the seedlings, and reduce the damage to the root systems during the transplanting.

In an embodiment, step (1) further includes: after the sowing N. tangutorum seeds at a depth of 2 centimeters, watering soil in each of the non-woven bags thoroughly for a first time with an amount of water being sufficient to reach saturation, to ensure that the soil is fully moistened, which helps the seedlings survive.

The disclosure provides the method for planting N. tangutorum in summer, with the following beneficial effects.

1. By optimizing the seedling cultivation, seedling lifting, seedling transportation, transplanting, shading, and irrigation management, the disclosure significantly improves the survival rate of N. tangutorum seedlings in high-temperature and arid environments. In practical application in the Karamay desert area, the survival rate of the N. tangutorum seedlings reaches 98%, which is much higher than the 80% survival rate of traditional spring bare-root seedlings. The disclosure is particularly suitable for extreme climatic conditions with high temperatures, little rainfall, and high evaporation rates, solves the problem of low survival rates of traditional planting methods in harsh environments, and provides an effective vegetation solution for ecological restoration in arid areas.

2. During the seedling lifting and transplanting processes, the disclosure uses the non-woven bags for the seedling cultivation, avoiding the water loss and mechanical damage to the root systems caused by exposure to air during transportation and transplanting of traditional bare-root seedlings. The non-woven bags are breathable and biodegradable, allowing the seedling roots to penetrate the bag walls and directly anchor into the soil. This ensures the natural extension of the root systems and close contact with the soil, effectively reducing root damage during transplantation and further increasing the survival rate of the seedlings.

3. In terms of irrigation management, the disclosure adopts a scientific irrigation frequency control. In the initial period after planting, irrigation is performed every three days to ensure that the seedlings receive sufficient water during the adaptation period. After 10 days, the irrigation frequency is adjusted to once every 10 days. By reducing the irrigation frequency, the growth of the N. tangutorum seedling roots is promoted into deeper soil layers, gradually cultivating their ability to obtain water on their own. This irrigation strategy not only conserves water resources but also enhances the drought resistance of the seedlings, enabling them to grow well even in water-scarce environments.

4. All steps of the disclosure, including the seedling cultivation, seedling lifting, seedling transportation, transplanting, shading, and irrigation management, are designed as standardized and easy-to-operate processes to ensure the reproducibility and simplicity of the method, making the method suitable for large-scale ecological restoration projects in desertification areas. Through standardized operating procedures, the disclosure can effectively reduce labor and technical costs, making it convenient for widespread application and providing efficient and sustainable technical support for ecological restoration and desertification prevention in arid and semi-arid regions.

### BRIEF DESCRIPTION OF DRAWINGS

FIG. 1 illustrates a schematic diagram of a N. tangutorum seedling in a non-woven bag according to the disclosure.

FIG. 2 illustrates a schematic diagram of the N. tangutorum seedling in a plastic transport box according to the disclosure.

FIG. 3 illustrates a schematic planting diagram according to an embodiment of the disclosure.

### DETAILED DESCRIPTION OF EMBODIMENTS

The technical solution of the disclosure will be clearly and completely described below in conjunction with the accompanying drawings. Apparently, the described embodiments are only a part of embodiments of the disclosure, and not all of them. Based on the embodiments of the disclosure, all other embodiments obtained by those skilled in the art without creative labor are within the scope of protection of the disclosure.

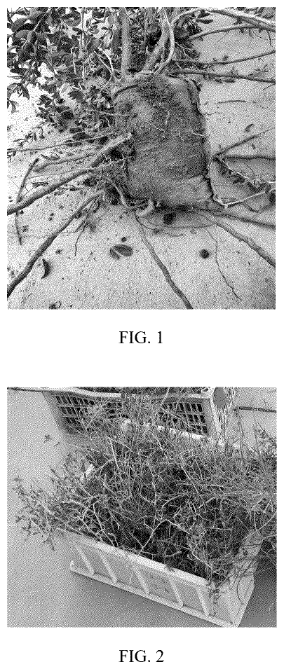

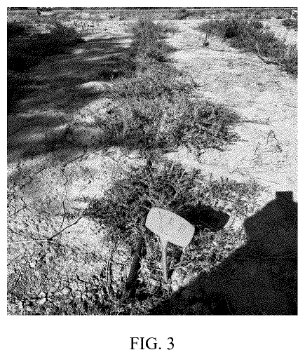

Referring to FIGS. 1-3, the disclosure provides a method for planting N. tangutorum in summer, including the following steps (1)-(7).

(1) Seedling cultivation: a square seedling plot is customized on a flat surface, sandy soil, loam, and farmyard manure are mixed uniformly in a ratio of 3:6:1 and then filled into non-woven bags, and N. tangutorum seeds are sown at a depth of 2 centimeters. The appropriate humidity is maintained before seedling emergence.

In the embodiment, a seedling plot is first demarcated on the flat surface. The seedling plot is constructed into a square structure using wooden boards each with a length of 1 meter, a width of 10 centimeters, and a thickness of 1 centimeter, for placing the non-woven seedling bags, ensuring the neat arrangement and stability of the bags. The seedling substrate is a uniform mixture of the sandy soil, the loam, and the farmyard manure in a ratio of 3:6:1. The sandy soil has good permeability and aeration, which helps prevent water logging that can cause seed rot; the loam provides moderate water retention and nutrients; and the farmyard manure, as an organic fertilizer, can supply the basic nutrients required for the early growth of the N. tangutorum seedlings.

In the embodiment, the prepared mixed substrate is filled into the non-woven fabric seedling bags. The specifications of each non-woven seedling bag are a height of 12 centimeters and an opening diameter of 6 centimeters. The non-woven seedling bags are biodegradable and will not impact the environment during the subsequent lifting and transplanting processes. Moreover, their good air permeability provides suitable respiratory conditions for the root system of N. tangutorum. After filling the seedling substrate into the seedling bags, the N. tangutorum seeds are sown into respective bags at a depth of 2 centimeters to provide an appropriate soil cover thickness for germination.

To break the dormancy of the N. tangutorum seeds and increase their germination rate, warm water treatment is adopted before sowing in this embodiment. The specific method is to soak the N. tangutorum seeds in boiled or warm water for 15 to 30 minutes. In this way, the seed coat can be effectively softened, the growth hormones inside the seeds can be activated, and germination can be facilitated. In addition, mechanical seed coat removing is performed on the seeds in this embodiment to remove the hard outer layer of the seeds and further increase the success germination rate.

After sowing is completed, the seedling substrate in the seedling bags is thoroughly watered for the first time to ensure that the soil reaches a saturated moist state. Thereafter, before the seedling emergence, an appropriate amount of water is sprinkled on the surface daily to maintain suitable humidity. After the seedlings have fully emerged, the watering frequency is adjusted to once every 5 days, gradually reducing the water supply to help the seedlings adapt to the environment and promote root growth.

Through the above seedling cultivation, healthy and well-developed seedlings can be provided for subsequent N. tangutorum planting steps, further increasing the survival rate and stress resistance of the seedlings in the later stages.

(2) Seedling lifting: when the seedlings grow to a height of 10-20 centimeters, the seedlings are gently removed along with the non-woven bags to ensure the integrity of the seedlings.

In this embodiment, to ensure the smooth operation of seedling lifting, the substrate in the seedling plot is thoroughly watered one day before the lifting process. This ensures that the soil reaches a high level of humidity, making the substrate soft and pliable, such that the pulling resistance on roots during lifting is reduced, minimizing the risk of root breakage or damage. Adequate soil moisture provides a moderate support level, allowing the seedlings and the substrate within the non-woven bags to be extracted stably.

During the lifting operation, this embodiment employs a gentle method including removing the seedlings along with the non-woven bags as a whole to maintain the integrity of the root systems and the stability of the substrate. The use of the non-woven bags plays a crucial role at this stage. The good air permeability and biodegradability of the non-woven bags provide additional protection for the roots during extraction. This prevents the exposed roots from direct contact with the external environment, reducing the stress on the seedling roots due to environmental changes.

When roots of some seedlings have penetrated the non-woven bags and extended into the substrate of the seedling plot, this embodiment recommends manually and gently excavating these roots. The specific operation includes: using a small trowel to dig along the outer edge of the corresponding non-woven bag to ensure that the extension of the roots is not disrupted and the structural integrity of the root system is maximized. This operation further reduces mechanical damage to the roots during lifting, providing stable root system support for the subsequent transplanting process.

Through the above scientifically rational seedling lifting process, this embodiment effectively reduces root damage caused by dry soil or improper handling during lifting. The watering before lifting and the use of the non-woven bags not only improve the efficiency of seedling lifting but also ensure that the seedlings have healthy root systems for transplanting. This allows N. tangutorum plants to quickly adapt to the new soil environment and establish themselves after transplanting.

(3) Seedling transportation: the removed seedlings are placed into plastic transport boxes, and their stems are trimmed to reduce water evaporation and ensure the tight arrangement of seedlings within the plastic transport boxes.

In this embodiment, the seedlings, after the seedling lifting, are neatly arranged into the plastic transport boxes each with a height of 30 centimeters. When loading the seedlings, a layer of soft material is first laid at the bottom of each plastic transport box to prevent damage to the root systems or the bottom of the non-woven bags caused by jolts during transportation. The soft material can be straw, sponge, or a foam pad, etc., which have good cushioning properties and can effectively protect the root system of the seedlings.

During loading, the arrangement of the seedlings is optimized in this embodiment, with the seedlings closely arranged to save space and reduce shaking. If it is found that the height of a seedling exceeds the height of the corresponding plastic transport box or the stems of the seedling are too long, it is recommended to trim the stems of the seedling appropriately so that the seedling can maintain a reasonable height within the corresponding plastic transport box, avoiding bending or crushing due to space limitations during transportation. The trimmed stems are usually the overly tall top parts, and trimming will not affect the subsequent growth of the seedlings.

After the plastic transport boxes are filled, the seedlings are loaded onto the transport vehicle for transportation. During this process, it is ensured that the transport boxes are placed stably, avoiding tilting or falling, to guarantee the integrity and freshness of the seedlings during transportation. Through the above scientific packing and fixing measures, the seedlings can arrive at the transplant site in good condition, providing assurance for the subsequent transplanting process.

(4) Transplanting and planting: planting holes are dug in a N. tangutorum planting area, the prepared nutrient bowl seedlings are placed into the planting holes, and the soil is back filled and gently firmed down with feet.

In this embodiment, the planting holes are dug in the N. tangutorum planting area. The dimension of each planting hole is 30 centimeters×30 centimeters×30 centimeters to ensure that the root systems of the seedlings have sufficient space to take root and can accommodate the entire placement of the non-woven bags. The locations and depths of the planting holes are designed to meet the growth requirements of the N. tangutorum, maintain good soil looseness, and ensure the healthy growth of the root systems after transplanting.

During the transplanting operation, this embodiment directly places the nutrient bowl seedlings in the non-woven bags into the planting holes, without the need to remove the non-woven bags. The non-woven bags have natural biodegradable properties, which allow them to gradually decompose in the soil without causing obstacles to the root systems of the seedlings. This also reduces the root damage that may be caused by the bag-removal operation in traditional transplanting.

After placing the seedlings into the planting holes, the soil that was originally excavated is back filled into the holes and gently firmed down to ensure close contact between the root systems and the soil, preventing the plants from becoming loose and affecting the root stability. During the back filling process, care is taken not to apply excessive pressure on the root systems of the seedlings, to maintain the appropriate looseness of the soil, which is conducive to further root expansion and growth. Through the above rational transplanting operations, the N. tangutorum seedlings can quickly adapt to the new environment and lay the foundation for subsequent growth.

(5) Planting: the seedlings are planted according to specifications of a row spacing of 3 meters and a plant spacing of 1 meter. Immediately after planting, sufficient water is applied for settling-in root to keep the soil moist.

In this embodiment, the N. tangutorum seedlings are planted with a row spacing of 3 meters and a plant spacing of 1 meter. The design of a row spacing of 3 meters and a plant spacing of 1 meter ensures that each N. tangutorum plant has sufficient light and ventilation, which is beneficial for root expansion and foliage growth, and prevents excessive competition for water and nutrients in the soil between plants. Moreover, this planting density facilitates subsequent irrigation and maintenance operations.

After planting is completed, in the embodiment, each N. tangutorum seedling is immediately watered with sufficient water for settling-in root to ensure that the root system is closely integrated with the surrounding soil and to reduce the stress response of the root system during transplantation. Thereafter, within 1 to 2 weeks after planting, the soil in the planting area is watered every 3 days to maintain the soil moisture in the planting area and meet the basic water needs of the seedlings. As the seedlings gradually adapt to the environment, appropriate amounts of supplementary water are added based on the actual ambient temperature and rainfall conditions to prevent the soil from becoming too dry or waterlogged.

Through above planting steps, this embodiment provides the N. tangutorum seedlings with a suitable growing space and water environment, helping the N. tangutorum seedlings to successfully get through the initial adaptation period after planting. This further increases the survival rate and lays the foundation for subsequent healthy growth.

(6) Shade net installation: a shade net is installed on each N. tangutorum seedling after the planting for seedling protection.

In this embodiment, after the seedlings are planted, a shade net is set up above each N. tangutorum seedling. The position and height of the shade net are reasonably adjusted according to the size of the corresponding seedling and the planting density to ensure that each seedling receives appropriate shade coverage. This prevents excessive water evaporation from the leaves and drying of the soil surface due to direct sunlight. The shade net is usually installed with some ventilation space to avoid excessive heat accumulation and to provide a soft light environment for the seedlings, meeting their basic needs for photosynthesis.

In this embodiment, the shade net is used continuously during the initial period after planting, typically covering for about 5 days. The shade net is then removed after the seedlings gradually adapt to the environment. The 5-day shading period provides a transitional environment for the seedlings, offering moderate protection during the adaptation phase and reducing stress reactions caused by sudden temperature changes.

By setting up shade nets during the initial planting period, this embodiment provides the necessary environmental buffering for the N. tangutorum seedlings, enabling them to grow smoothly under the hot summer conditions and laying the foundation for their subsequent natural adaptation and healthy development.

(7) Irrigation: watering is performed every three days to ensure adequate soil moisture.

In this embodiment, during the first 10 days after planting, the planting area is watered every three days to maintain an appropriate level of soil moisture, meeting the initial growth requirements of the seedlings. After the seedlings have successfully adapted to the new environment and survived, the irrigation frequency is adjusted to once every 10 days in this embodiment, to train the seedlings to gradually adapt to relatively drier environmental conditions. The amount of water applied each time is controlled to be 30% to 50% of the soil volume of the planting holes, ensuring that the soil around the root systems is moist but not waterlogged, thus preventing root hypoxia due to excessive wetness.

This irrigation method helps to reduce water dependency gradually, enhancing the drought resistance of the seedlings after the adaptation period, while also avoiding the adverse effects of water logging, ultimately promoting the robust growth of N. tangutorum in arid environments.

### Embodiment 1

The method is used for ecological restoration and construction in the Karamay area of Xinjiang, China, with the implementation site selected in the desert area on the outskirts of Karamay City. Located on the edge of the Junggar Basin in the northwest of Xinjiang, Karamay has a typical temperate continental climate, characterized by dry weather, scarce precipitation, and high evaporation rates, making the natural environment harsh. The average annual temperature is 8.3° C., with an extreme maximum temperature reaching 39.1° C. The annual precipitation is only 95.8 millimeters, while the annual evaporation amount is as high as 1,595.1 millimeters. The region experiences high temperatures and little rainfall in summer, and the survival rate of plants is a key challenge in ecological restoration. To improve the survival rate of N. tangutorum in the desert area, the implementation date of the disclosure is chosen to be June 29th. Based on the specific technical solutions, an improved summer planting method is adopted. The specific implementation steps are as follows.

Spring seedling cultivation: In early spring, a square seedling plot is constructed on a flat surface using wooden boards each with a length of 1 meter, a width of 10 centimeters, and a thickness of 1 centimeter. Sandy soil, loam, and farmyard manure are mixed in a ratio of 3:6:1 to obtain a mixture as a substrate for seedling cultivation, and the mixture is filled into non-woven bags. The specification of each non-woven bag is a height of 12 centimeters and an opening diameter of 6 centimeters. These non-woven bags are breathable and naturally biodegradable, and will not cause environmental pollution and will allow the roots of N. tangutorum to penetrate the bag walls and grow into the soil in the later stages of growth. The non-woven bags are neatly arranged in the seedling plot, and N. tangutorum seeds are sown at a depth of 2 centimeters in respective non-woven bags. Before sowing, the seeds are soaked in warm water for 15 to 30 minutes followed by seed coat removing to break the dormancy of the seeds and promote germination. After sowing, the substrate in the non-woven bags is thoroughly watered for the first time to reach saturation, ensuring adequate water absorption by the seeds. The surface of the substrate is sprinkled with water daily before seedling emergence to maintain moisture. Once the seedlings have emerged uniformly, the watering frequency is adjusted to once every 5 days to acclimate the seedlings to a drier environment.

Seedling lifting in the second summer: In summer of a next year, when the seedlings have grown to a height of 10-20 centimeters, the operation of seedling lifting begins. To minimize interference with the root system during the lifting process, the substrate is thoroughly watered the day before lifting to increase humidity and soften the substrate. The next day, the seedlings are gently removed along with the non-woven bags. If the root systems of some seedlings have penetrated the corresponding non-woven bags and extended into the substrate of the seedling plot, it is necessary to carefully dig around the periphery of the corresponding non-woven bags to ensure the integrity of the root systems. This operation not only preserves the integrity of the root systems but also reduces the risk of reduced survival rate due to mechanical damage.

Seedling transportation: The removed seedlings are neatly arranged into plastic transport boxes each with a height of 30 centimeters to ensure that the seedlings are stable and tightly packed during transportation, reducing damage caused by jolts. Before loading, a layer of soft material (such as straw, sponge, or foam pad) is laid at the bottom of each transport box to further cushion any vibrations that may occur during transportation. If the height of a seedling exceeds the height of the corresponding transport box, the top stems of the seedling are trimmed appropriately so that the seedlings can be tightly packed after being loaded into the transport boxes. The trimmed seedlings will not be affected in their normal growth after transplanting. After the transport boxes are filled, the seedlings are loaded onto the transport vehicle and taken to the planting site.

Transplanting and planting: The transplanting operation is performed on cloudy or rainy days, or in the afternoon when the high temperature has subsided, to mitigate the impact of direct sunlight on the seedlings. At the planting area, planting holes are dug according to the root growth requirements of the N. tangutorum seedlings, and each planting hole has a dimension of 30 centimeters×30 centimeters×30 centimeters. The seedlings, along with their non-woven bags, are placed into the planting holes without removing the non-woven bags. The non-woven bags will naturally decompose, facilitating root expansion and avoiding root damage that may be caused by bag removal. The excavated soil is back filled into the planting holes and gently firmed down to ensure close contact between the roots and the soil, enhancing soil stability.

Summer Planting: A planting density with a row spacing of 3 meters and a plant spacing of 1 meter is adopted, which not only provides sufficient growing space for the N. tangutorum seedlings but also facilitates subsequent management. Immediately after planting, each seedling is thoroughly watered to ensure the soil is moist and to help the seedlings take roots in the new environment. During 1 to 2 weeks after planting, the soil in the planting holes is watered every 3 days to keep the soil in the planting holes moist and to avoid water logging; subsequently, watering is adjusted according to the actual ambient temperature and rainfall to maintain soil moisture without water logging, thus preventing root suffocation of the seedlings.

Shade net installation: To prevent the impact of direct high-temperature sunlight on the seedlings, a shade net is installed above each N. tangutorum seedling immediately after planting. This reduces the intensity of sunlight, lowers the temperature around the seedlings, and minimizes water evaporation. The shade net is typically in place for 5 days, and then removed once the seedlings have gradually adapted to the external temperature, helping the seedlings acclimate to the natural light environment.

Irrigation management: In the first 10 days after planting, watering is performed every three days to ensure that the soil around the seedlings maintains a moderate level of moisture, aiding the seedlings in successfully getting through the adaptation period. After 10 days, the irrigation frequency is gradually adjusted to once every 10 days, allowing the N. tangutorum seedlings to progressively adapt to arid conditions. The amount of water applied each time is controlled to be 30% to 50% of the soil volume of the planting holes, preventing water logging that could cause root suffocation while also encouraging the roots to grow deeper into the soil layer, enhancing drought resistance.

Implementation effect: The climate in the Karamay area is extremely arid, with annual precipitation far less than the evaporation rate, making it difficult for plants to survive in the early stages of planting. Through the technical measures of the disclosure, the survival rate of N. tangutorum seedlings has reached 98%, significantly higher than the 80% survival rate of traditional spring bare-root seedlings.

Although an embodiment of the present invention has been shown and described, the invention is also applicable to other desert plants, such as Haloxylon ammodendron, Tamarix chinensis, and Calligonum mongolicum. For those of ordinary skill in the art, it can be understood that various changes, modifications, substitutions, and variations can be made to these embodiments without departing from the principles and spirit of the disclosure, the scope of which is defined by the appended claims and their equivalents.

What is claimed is:

1. A method for planting Nitraria tangutorum (N. Tangutorum) in summer, comprising the following steps:
(1) seedling cultivation, comprising: customizing a square seedling plot on a flat surface, mixing sandy soil, loam, and farmyard manure to obtain a mixture, filling the mixture into non-woven bags, sowing N. tangutorum seeds at a depth of 2 centimeters, and maintaining an appropriate humidity before seedling emergence;
(2) seedling lifting, comprising: removing, when seedlings grow to a height of 10-20 centimeters, the seedlings along with the non-woven bags to ensure integrity of the seedlings to obtain removed seedlings;
(3) seedling transportation, comprising: placing the removed seedlings into plastic transport boxes and trimming stems to obtain prepared nutrient bowl seedlings;
(4) transplanting: digging planting holes in a N. tangutorum planting area, placing the prepared nutrient bowl seedlings into the planting holes respectively, and back filling and firming down soil with feet;
(5) planting, comprising: planting according to specifications of a row spacing of 3 meters and a plant spacing of 1 meter, and then immediately watering thoroughly for settling-in root to keep the soil moist;
(6) shade net installation, comprising: installing a shade net on each N. tangutorum seedling after the planting for seedling protection; and
(7) irrigation, comprising: performing watering every three days to ensure adequate soil moisture.

2. The method as claimed in claim 1, wherein before the sowing N. tangutorum seeds at a depth of 2 centimeters, step (1) further comprises: soaking the N. tangutorum seeds in warm water or boiled water for a period of 15-30 minutes, and performing a mechanical seed coat removing method or a chemical soaking method.

3. The method as claimed in claim 1, wherein in step (1), a mixed ratio of the sandy soil to the loam to the farmyard manure is 3:6:1.

4. The method as claimed in claim 1, wherein in step (3), a height of each of the plastic transport boxes is 30 centimeters, and step (3) further comprises: laying, when loading the removed seedlings, a layer of soft material comprising straw, sponge, or a foam pad at a bottom of each of the plastic transport boxes to reduce vibration and damage to root systems of the removed seedlings during transportation.

5. The method as claimed in claim 1, wherein in step (4), a dimension of each of the planting holes is 30 centimeters×30 centimeters×30 centimeters.

6. The method as claimed in claim 1, wherein step (5) further comprises: watering every three days within 1 to 2 weeks after the planting.

7. The method as claimed in claim 1, wherein step (6) further comprises: removing the shade net after each N. tangutorum seedling has grown for 5 days.

8. The method as claimed in claim 1, wherein step (7) further comprises: after each N. tangutorum seedling has survived for 10 days, adjusting, based on a seedling growth condition and an environmental humidity, an irrigation frequency to watering every 10 days, wherein an amount of water each time is 30%-50% of a soil volume of the planting holes to maintain moisture required for normal growth.

9. The method as claimed in claim 1, wherein step (2) further comprises: watering thoroughly one day before the seedling lifting, to increase soil moisture and ensure integrity of root systems of the seedlings.

10. The method as claimed in claim 1, wherein step (1) further comprises: after the sowing Ni. tangutorum seeds at a depth of 2 centimeters, watering soil in each of the non-woven bags thoroughly for a first time with an amount of water being sufficient to reach saturation, to ensure that the soil is fully moistened.
